(19) United States
(12) Patent Application Publication
(10) Pub. No.: US 2016/0246067 A1
(43) Pub. Date: Aug. 25, 2016

(54) METHOD FOR MANUFACTURING PATTERN RETARDER

(71) Applicants: BOE TECHOLOGY GROUP CO., LTD., Beijing (CN); HEFEL BOE OPTOELECTRONIC TECHNOLOGY CO., LTD., Hefei, Anhui (CN)

(72) Inventor: Yunbok LEE, Beijing (CN)

(21) Appl. No.: 14/437,126

(22) PCT Filed: Sep. 2, 2014
(86) PCT No.: PCT/CN2014/085729

§ 371 Date: Apr. 20, 2015

(30) Foreign Application Priority Data
Apr. 10, 2014 (CN) 201410143020.4

(51) Int. Cl. G02B 27/26; G02B 5/30

(52) U.S. Cl. CPC G02B 27/26; G02B 5/3083; G02B 5/3041

(57) ABSTRACT

A method for manufacturing a pattern retarder, which comprises: forming films (2, 5) on a base substrate (1), patterning the films (2, 5) by means of a laser, and forming a region of left-handed circularly polarized light (4) and a region of right-handed circularly polarized light (6). The method for manufacturing the pattern retarder can ensure the alignment accuracy between the pattern retarder and a display panel and ensure the yield ratio of 3D products.

### TECHNICAL FIELD

Embodiments of the present disclosure relate to a method for manufacturing a pattern retarder.

### BACKGROUND

Three-dimensional (3D) display has become a trend in the display field. The basic operation principle of 3D display is to utilize parallax to produce 3D images, namely the left eye of an observation sees a left-eye image and the right eye of the observation sees a right-eye image, wherein the left-eye image and the right-eye image are a 3D image pair with parallax.

Currently, polarized glasses type 3D display is the mainstream of 3D display technology. The basic configuration of such a technology is to mount a device capable of adjusting the polarization direction of emergent light in front of a display panel. The device can be a pattern retarder, a liquid crystal cell or other device capable of adjusting the polarization direction of emergent light of various pixels. In various polaroid glasses 3D displays, a technology employing the pattern retarder is the most popular. The basic structure of the technology is that: a pattern retarder is accurately positioned on and attached to the display panel and different pattern retards can be obtained through different regions on the pattern retarder, and hence light from different pixels can be emitted in different polarization directions and an observation can see the 3D effect by wearing polaroid glasses.

The inventor found that: the current method for manufacturing a 3D display panel based on a pattern retarder is to manufacture the pattern retarder on a glass substrate or a film substrate at first and then attach the pattern retarder to the display panel by double-sided adhesive tape or other adhesives. The problem existing in the process of manufacturing the pattern retarder is that: when positioning and attaching the pattern retarder the display panel, accurate positioning can be difficultly achieved, so that the accuracy is very low and hence the yield rate of 3D products manufactured by this method is very low and crosstalk problem is serious.

### SUMMARY

One of technical problems to be solved by embodiments of the present disclosure is to provide a method for manufacturing a pattern retarder which can ensure the positioning accuracy between the pattern retarder and a display panel and ensure the yield of 3D products.

At least one embodiment of the present disclosure provides a method for manufacturing a pattern retarder, which comprises:

forming films on a base substrate, patterning the films by means of laser, and forming a region of left-handed circularly polarized light and a region of right-handed circularly polarized light.

The films comprise a first film and a second film.

Forming films on the base substrate, patterning the films by means of laser, and forming a region of left-handed circularly polarized light and a region of right-handed circularly polarized light comprises:

forming a first film on the base substrate;

patterning the first film by means of laser and forming a region of left-handed circularly polarized light;

forming a second film on the base substrate; and

patterning the second film by means of laser and forming a region of right-handed circularly polarized light.

The region of left-handed circularly polarized light comprises the first film, and the region of right-handed circularly polarized light comprise the second film.

Forming films on the base substrate, patterning the films by means of laser, and forming a region of left-handed circularly polarized light and a region of right-handed circularly polarized light comprises:

forming a first film on the base substrate;

forming a second film on the first film; and

patterning the second film and forming a region of left-handed circularly polarized light and a region of right-handed circularly polarized light.

The region of left-handed circularly polarized light comprises the first film, and the region of right-handed circularly polarized light comprises the first film and the second film superimposed stacked.

Both the region of left-handed circularly polarized light and the region of right-handed circularly polarized light are strip-shaped; and a plurality of regions of left-handed circularly polarized light and a plurality of regions of right-handed circularly polarized light are arranged alternately.

In the technical proposal of the embodiment of the present disclosure, as the laser has high luminance and good unidirectivity, thus traveling routine of the laser can be set directly and the laser can be used to pattern corresponding film formed on the base substrate, so that partial area on the film is irradiated and heated by the laser. The heated partial area will lift off from the base substrate, and a region of left-handed circularly polarized light and a region of right-handed circularly polarized light are formed in the retained partial area. Thus, accuracy of the regions of left-handed circularly polarized light and the region of right-handed circularly polarized light can be guaranteed without a mask. And at the same time, the film can also be directly formed on the base substrate of the display panel, and the region of left-handed circularly polarized light and the region of right-handed circularly polarized light are formed by direct alignment in the patterning process by means of the laser. Thus, alignment deviations between the region of left-handed circularly polarized light and the display panel and between the region of right-handed circularly polarized light and the display panel can be avoided, and hence the 3D viewing effect of users cannot be affected.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a flowchart 1 of a method for manufacturing a pattern retarder, according to an embodiment of the present disclosure;

FIG. 2 is a flowchart 2 of the method for manufacturing the pattern retarder, according to the embodiment of the present disclosure;

FIG. 3 is a schematic structural view 1 of the pattern retarder according to the embodiment of the present disclosure;

FIG. 4 is a schematic structural view 2 of the pattern retarder according to the embodiment of the present disclosure;

FIG. 5 is a schematic structural view 3 of the pattern retarder according to the embodiment of the present disclosure;

FIG. 6 is a schematic structural view 4 of the pattern retarder according to the embodiment of the present disclosure;

FIG. 7 is a schematic structural view 5 of the pattern retarder according to the embodiment of the present disclosure;

FIG. 8 is a flowchart 3 of the method for manufacturing the pattern retarder, according to the embodiment of the present disclosure;

FIG. 9 is a schematic structural view 6 of the pattern retarder according to the embodiment of the present disclosure;

FIG. 10 is a schematic structural view 7 of the pattern retarder according to the embodiment of the present disclosure; and

FIG. 11 is a schematic structural view 8 of the pattern retarder according to the embodiment of the present disclosure.

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

### First Embodiment

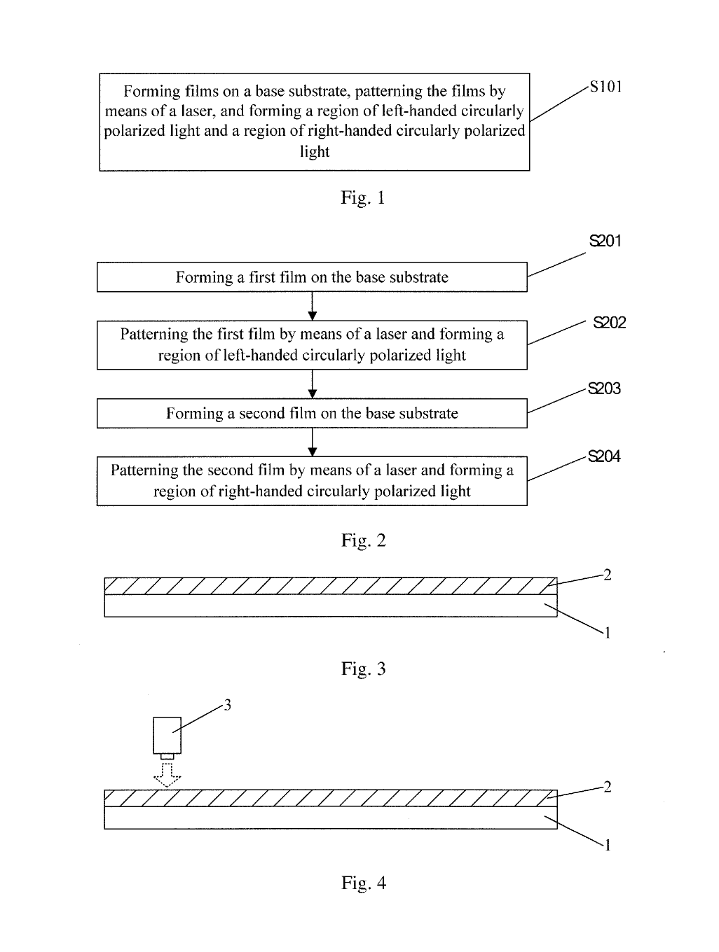

The embodiment of the present disclosure provides a method for manufacturing a pattern retarder. As illustrated in FIG. 1, the method for manufacturing the pattern retarder comprises:

Step 101: forming films on a base substrate, patterning the films by means of a laser, and forming a region of left-handed circularly polarized light and a region of right-handed circularly polarized light.

Polaroid glasses 3D display is current mainstream of 3D display technology. Among various polaroid glasses 3D displays, the technology employing the pattern retarder is the most popular. The principle structure of the technology is that: a pattern retarder is attached to a display panel and different pattern retardations can be produced through different regions on the pattern retarder, and hence light of different pixels can be emitted in different polarization directions and a viewer can see the 3D display effect by wearing polaroid glasses.

The operation principle of the pattern retarder 3D display is as below: an image displayed on a display panel, a pattern retarder, an emergent image and a pair of polaroid glasses for viewing. On the display panel, one row displays a right-eye image and one row displays a left-eye image. A pattern retarder is placed in front of the display panel. λ/4 retardation is applied to one row and one row adopts 3λ/4 retardation, wherein λ refers to the optical wavelength. In this case, left-handed circularly polarized light and right-handed circularly polarized light can be formed respectively. Thus, when a viewer wears a pair of polaroid glasses in which the polarization directions of the left lens and the right lens are orthogonal, the right eye can only see light emitted from right-eye pixels and the left eye can only see light emitted from left-eye pixels, and hence a 3D image can be produced.

In the technical proposal of the embodiment of the present disclosure, as the laser has high luminance and good unidirectivity, thus traveling routine of the laser can be set directly and the laser can be used to pattern corresponding film formed on the base substrate, so that partial area on the film is irradiated and heated by the laser. The heated partial area will lift off from the base substrate, and regions of left-handed circularly polarized light and regions of right-handed circularly polarized light are formed in the retained partial area. Thus, accuracy of the region of left-handed circularly polarized light and the region of right-handed circularly polarized light can be guaranteed without a mask. And at the same time, the film can also be directly formed on the base substrate of the display panel, and the region of left-handed circularly polarized light and the region of right-handed circularly polarized light are formed by direct alignment in the patterning process by means of the laser. Thus, alignment deviations between the region of left-handed circularly polarized light and the display panel and between the region of right-handed circularly polarized light and the display panel can be avoided, and hence the 3D viewing effect of users cannot be affected.

The film is relatively sensitive to the laser and may be made from materials such as mesogen, polyethylene terephthalate (PET) and polycarbonate (PC).

And further, in order to form the region of left-handed circularly polarized light and the region of right-handed circularly polarized light regions, the films may correspondingly include a first film and a second film.

In the embodiment of the present disclosure, as illustrated in FIG. 2, the step 101 can comprise:

Step 201: forming a first film on the base substrate.

As illustrated in FIG. 3, a first film 2, e.g., a λ/4 film, is formed on a base substrate 1, wherein λ refers to the optical wavelength.

Step 202: patterning the first film by means of a laser and forming a region of left-handed circularly polarized light.

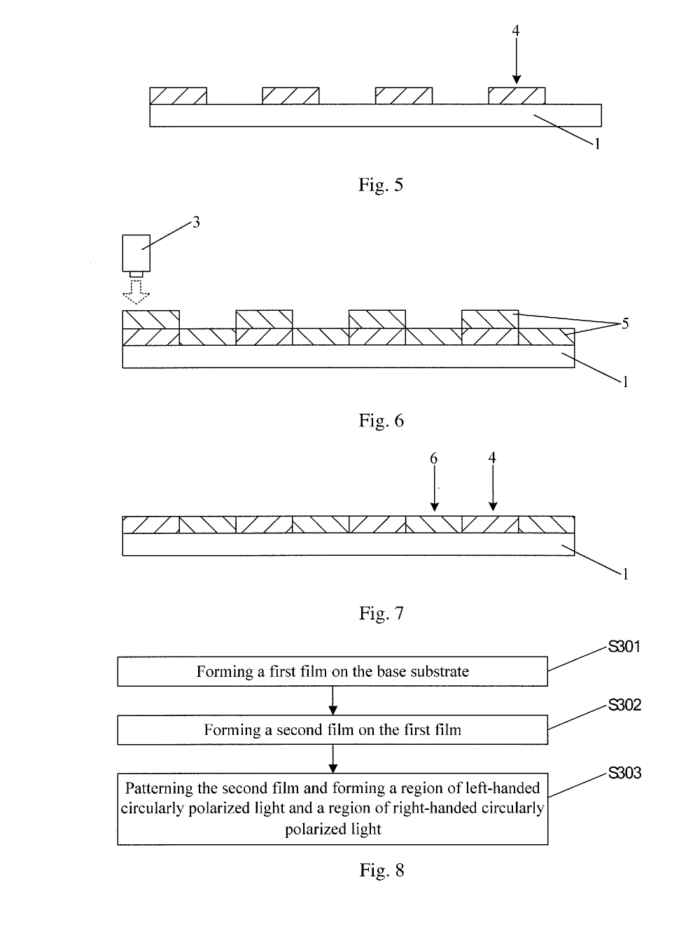

A laser 3 is programmed to move along a predetermined path and meanwhile emit laser to perform laser irradiation and heating on partial area of the first film 2, as illustrated in FIG. 4. Areas on the first film 2 subjected to laser heating will be lifted off from the base substrate 1. After the lifted first film 2 is stripped off, a region of left-handed circularly polarized light 4 is formed, as illustrated in FIG. 5.

Step 203: forming a second film on the base substrate.

Similarly, as illustrated in FIG. 6, a second film 5, e.g., a 3λ/4 film, used for forming a region of right-handed circularly polarized light 6, is formed on the base substrate 1 on which the region of left-handed circularly polarized light 4 is formed, wherein 2 refers to the optical wavelength.

Step 204: patterning the second film by means of a laser and forming a region of right-handed circularly polarized light.

Similar to the step 202, after laser irradiation, areas on the second film 5 subjected to laser heating will be lifted off from the base substrate 1. After the lifted second film 5 is stripped off, a region of right-handed circularly polarized light 6 are formed. As illustrated in FIG. 7, both the region of left-handed circularly polarized light 4 and the region of right-handed circularly polarized light 6 are strip-shaped. The left-handed region of circularly polarized light 4 and the region of right-handed circularly polarized light 6 are arranged alternately.

Obviously, on the pattern retarder formed by the manufacturing method as illustrated in FIG. 2, the region of left-handed circularly polarized light 4 comprises the first film 2, and the region of right-handed circularly polarized light 6 comprises the second film 5.

The factors such as the wavelength and the intensity of the laser emitted by the laser 3 should be adjusted according to the material and thickness of the film heated by the laser 3. No specific limitation will be set forth in the embodiment of the present disclosure.

In addition, in the manufacturing method as illustrated in FIG. 2, the region of right-handed circularly polarized light 6 can be formed first and then the region of left-handed circularly polarized light 4 is formed. No further description will be given in the embodiment of the present application.

And moreover, as illustrated in FIG. 8, the step 101 can further comprise:

S301: forming a first film on a base substrate.

As illustrated in FIG. 3, a first film 2, e.g., a λ/4 film, is formed on the base substrate 1, wherein λ refers to the optical wavelength.

S302: forming a second film on the first film.

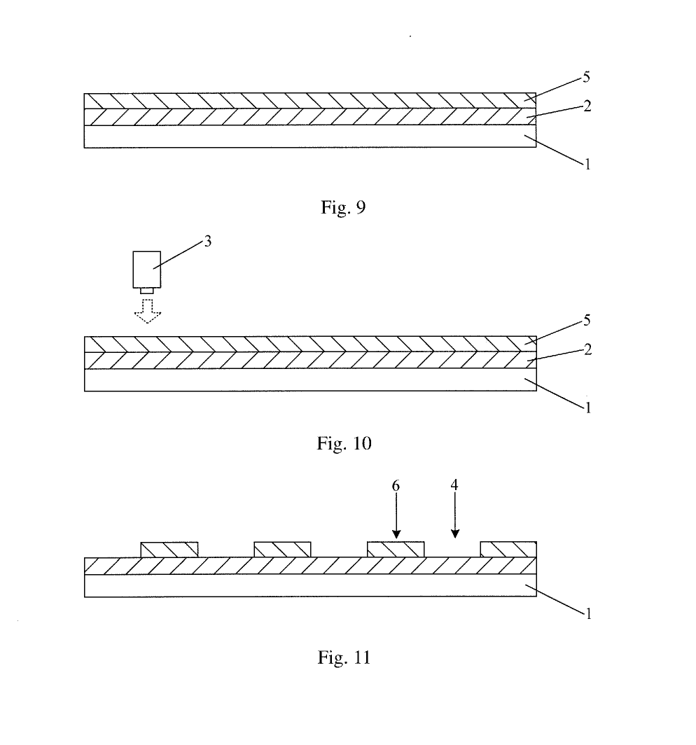

As illustrated in FIG. 9, on the basis of FIG. 3, a second film 5, e.g., a λ/2 film, is formed on the first film 2, wherein λ refers to the optical wavelength.

S303: patterning the second film and forming a region of left-handed circularly polarized light and a region of right-handed circularly polarized light.

A laser 3 is programmed to move along a predetermined path and meanwhile emit laser to perform laser irradiation and heating on partial areas of the second film 5, as illustrated in FIG. 10. Areas on the second film 5 subjected to laser heating will be lifted off from the first film 2. After the lifted second film 5 is stripped off, a region of left-handed circularly polarized light 4 and a region of right-handed circularly polarized light 6 are formed, as illustrated in FIG. 11.

Obviously, in the manufacturing method as illustrated in FIG. 8, the region of left-handed circularly polarized light 4 comprises the first film 2, and the region of right-handed circularly polarized light 6 comprises the first film 2 and the second film 5 stacked.

The factors such as the wavelength and the intensity of the laser emitted by the laser 3 should be adjusted according to the material and thickness of the film heated by the laser 3 to prevent the laser from heating the first film 2 used for forming the region of left-handed circularly polarized light 4, which will cause the first film 2 to be lifted off.

Similar to the pattern retarder formed by the manufacturing method as illustrated in FIG. 2, in the pattern retarder formed by the manufacturing method as illustrated in FIG. 8, both the region of left-handed circularly polarized light 4 and the region of right-handed circularly polarized light 6 are strip-shaped, and the region of left-handed circularly polarized light 4 and the region of right-handed circularly polarized light 6 are arranged alternately.

Furthermore, the pattern retarder formed in the embodiment of the present disclosure not only can be applied in the display panel to manufacture a 3D display device but also can be used for forming polarized 3D glasses. No further description will be given here.

The foregoing are merely exemplary embodiments of the disclosure, but are not used to limit the protection scope of the disclosure. The protection scope of the disclosure shall be defined by the attached claims.

The present disclosure claims priority of Chinese Patent Application No. 201410143020.4 filed on Apr. 10, 2014, the disclosure of which is hereby entirely incorporated by reference.

1. A method for manufacturing a pattern retarder, comprising:
forming films on a base substrate, patterning the films by means of a laser, and forming a region of left-handed circularly polarized light and a region of right-handed circularly polarized light.

2. The manufacturing method according to claim wherein
the films comprise a first film and a second film.

3. The manufacturing method according to claim 2, wherein forming films on a base substrate, patterning the films by means of a laser, and forming a region of left-handed circularly polarized light and a region of right-handed circularly polarized light comprises:
forming the first film on the base substrate;
patterning the first film by means of the laser and forming the region of left-handed circularly polarized light;
forming the second film on the base substrate; and
patterning the second film by means of the laser and forming the region of right-handed circularly polarized light.

4. The manufacturing method according to claim 2, wherein the region of left-handed circularly polarized light comprises the first film, and the region of right-handed circularly polarized light comprises the second film.

5. The manufacturing method according to claim 2, wherein forming films on the base substrate, patterning the films by means of a laser, and forming a region left-handed circularly polarized light and a region of right-handed circularly polarized light comprises:
forming a first film on the base substrate:
forming a second film on the first film; and
patterning the second film and forming the region of left-handed circularly polarized light and the region of right-handed circularly polarized light.

6. The manufacturing method according to claim 2, wherein the region of left-handed circularly polarized light comprises the first film, and the region of right-handed circularly polarized light comprises the first film and the second film stacked.

7. The manufacturing method according to claim 1, wherein
both the region of left-handed circularly polarized light and the region of right-handed circularly polarized light are strip-shaped; and a plurality of regions of left-handed circularly polarized light regions and a plurality of regions of right-handed circularly polarized light are arranged alternately.

8. The manufacturing method according to claim 3, wherein the region of left-handed circularly polarized light comprises the first film, and the region of right-handed circularly polarized light comprises the second film.

9. The manufacturing method according to claim 5, wherein the region of left-handed circularly polarized light comprises the first film, and the region of right-handed circularly polarized light comprises the first film and the second film stacked.

10. The manufacturing method according to claim 2, wherein
both the region of left-handed circularly polarized light and the region of right-handed circularly polarized light are strip-shaped; and a plurality of regions of left-handed circularly polarized light regions and a plurality of regions of right-handed circularly polarized light are arranged alternately.

11. The manufacturing method according to claim 3, wherein
both the region of left-handed circularly polarized light and the region of right-handed circularly polarized light are strip-shaped; and a plurality of regions of left-handed circularly polarized light regions and a plurality of regions of right-handed circularly polarized light are arranged alternately.

12. The manufacturing method according to claim 4, wherein
both the region of left-handed circularly polarized light and the region of right-handed circularly polarized light are strip-shaped; and a plurality of regions of left-handed circularly polarized light regions and a plurality of regions of right-handed circularly polarized fight are arranged alternately.

13. The manufacturing method according to claim 5, wherein
both the region of left-handed circularly polarized light and the region of right-handed circularly polarized light are strip-shaped; and a plurality of regions of left-handed circularly polarized light regions and a plurality of regions of right-handed circularly polarized light are arranged alternately.

14. The manufacturing method according to claim 6, wherein
both the region of left-handed circularly polarized fight and the region of right-handed circularly polarized light are strip-shaped; and a plurality of regions of left-handed circularly polarized light regions and a plurality of regions of right-handed circularly polarized light are arranged alternately.

15. The manufacturing method according to claim 8, wherein
both the region of left-handed circularly polarized fight and the region of right-handed circularly polarized light are strip-shaped; and a plurality of regions of left-handed circularly polarized light regions and a plurality of regions of right-handed circularly polarized fight are arranged alternately.

16. The manufacturing method according to claim 9, wherein both the region of left-handed circularly polarized light and the region of right-handed circularly polarized light are strip-shaped; and a plurality of regions of left-handed circularly polarized light regions and a plurality of regions of right-handed circularly polarized light are arranged alternately.
